(19) United States
(12) Patent Application Publication
(10) Pub. No.: US 2016/0104121 A1
(43) Pub. Date: Apr. 14, 2016

(54) Digital Flyer Service

(71) Applicant: Benjamin Garner, White Salmon, WA (US)

(72) Inventor: Benjamin Garner, White Salmon, WA (US)

(21) Appl. No.: 14/512,114

(22) Filed: Oct. 10, 2014

(51) Int. Cl. G06Q 10/10; H04N 5/232; G06F 17/30

(52) U.S. Cl. CPC G06Q 10/1095; G06F 17/30864; H04N 5/23238

(57) ABSTRACT

The instant application discloses, among other things, a Digital Flyer Service. In one embodiment, it may comprise a software application for a mobile device which may allow a user to search for and view digital images of flyers around the world. The search may be based on various filters such as location, hashtags or event categories, for example. Digital Flyer Service may also allow users to take a photo of a flyer and have the photo and details, such as event information, for example, uploaded to a searchable database. The database may be accessible through an application on a mobile device, for example. Users may also integrate the flyers and details with their personal calendars and online social networks, for example.

### FIELD

This disclosure relates generally to a Digital Flyer Service.

### BACKGROUND

Many people around the world use flyers to get the word out about concerts, garage sales, town hall meetings, missing persons, or lost pets, for example. Flyers may be mounted on utility poles, buildings, and bulletin boards, among other places. Unfortunately, people rarely have enough time to read all of the information contained in a flyer. Even if they did, it may take a substantial amount of time to integrate the information with their calendars or online social networks, for example. It is also difficult for people to view flyers that are posted in different cities, states, or countries, for example, as the flyer details may not be published or accessible online.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a Digital Flyer Service. In one embodiment, it may comprise a software application for a mobile device, for example, which may allow a user to search a database for digital images of flyers around the world. The search may be based on a location entered by the user or by a person's actual location as determined by a global positioning system (GPS), for example. Users may also employ any combination of search filters.

Digital Flyer Service may also allow users to take a picture of any flyer and have the picture and details, such as event information, for example, added to the flyer database. Users may integrate the flyers and details with their personal calendars and online social networks, for example.

Many of the attendant features may be more readily appreciated as they become better understood by reference to the following detailed description considered in connection with the attached drawings.

### BRIEF DESCRIPTION OF THE DRAWINGS

FIG. 1 is a flow diagram illustrating a Digital Flyer Service process according to one embodiment.

FIG. 2 is a flow diagram illustrating a Digital Flyer Service process according to another embodiment.

FIG. 3 illustrates a welcome screen for a mobile device application using a Digital Flyer Service, according to one embodiment.

FIG. 4 illustrates a flyer viewer for a mobile device application using a Digital Flyer Service, according to one embodiment.

FIG. 5 illustrates an event details viewer for a mobile device application using a Digital Flyer Service, according to one embodiment.

FIG. 6 illustrates a search page for a mobile device application using a Digital Flyer Service, according to one embodiment.

FIG. 7 illustrates a calendar for a device mobile application using a Digital Flyer Service, according to one embodiment.

FIG. 8 illustrates a photo capture screen for a mobile device application using a Digital Flyer Service, according to one embodiment.

FIG. 9 illustrates an edit details screen for a mobile device application using a Digital Flyer Service, according to one embodiment.

FIG. 10 illustrates a map, with a user location located near a road.

FIG. 11 is a block diagram illustrating an example of a system capable of supporting a Digital Flyer Service, according to one embodiment.

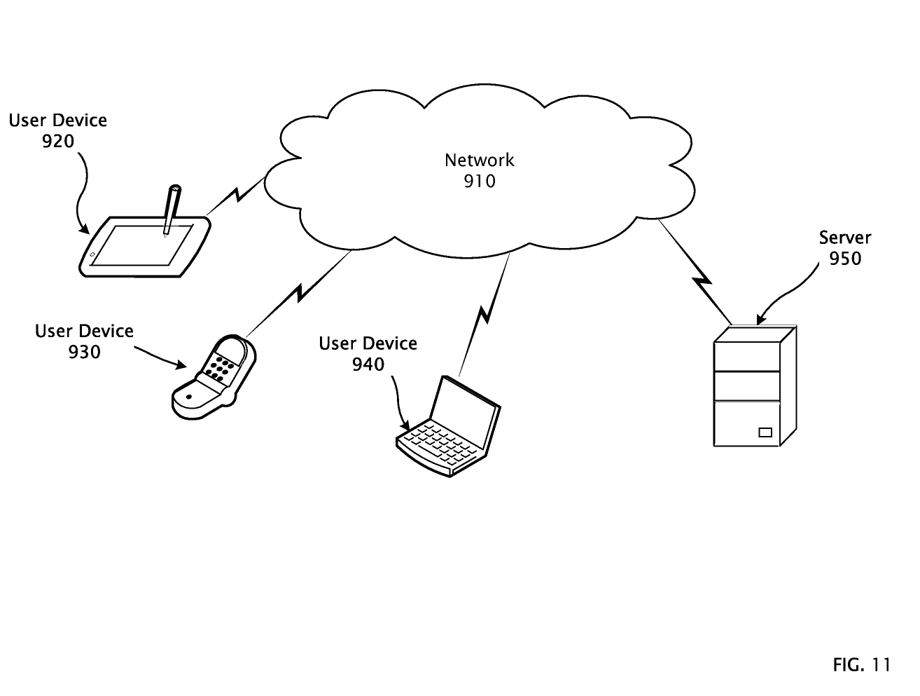

FIG. 12 is k diagram of a computing device to which a Digital Flyer Service process may be applied according to one embodiment.

Like reference numerals are used to designate like parts in the accompanying drawings.

### DETAILED DESCRIPTION

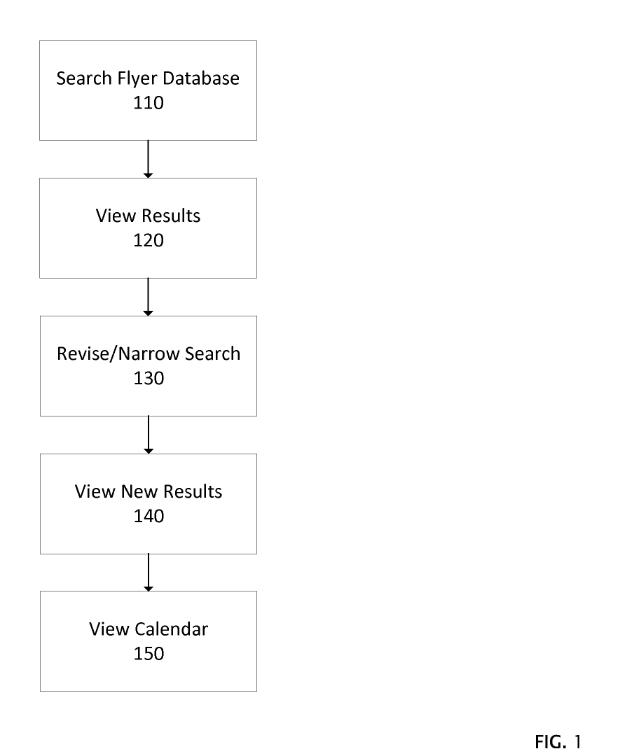

FIG. 1 is a flow diagram illustrating a Digital Flyer Service process according to one embodiment. At Search Flyer Database 110, a user may search a database of flyers around the world. In one embodiment, a user may enter a desired flyer or event location, such as Portland, or by using the user's actual location as determined by any means, such as a global positioning system (GPS) through their mobile device, for example. At View Results 120, a results list and digital images of flyers may be displayed. A user may browse various flyers, for example, by swiping the screen, pressing a button, shaking or tilting a device, or performing any other action. Images of flyers may also appear automatically. A user may view flyer details, such as event title, description, cost or suggested donation, date, time, address, search tags, and categories, for example, by performing an action such as clicking on the image of a flyer, for example, or details may appear automatically A screen may also provide links to maps, ticket merchants, social networks such as Facebook, Twitter, Pinterest, and Instagram, or an event URL, for example.

If an initial location search produces no results, a screen may appear indicating that no flyers or events were found and may provide other options for a user. For example, a screen may include buttons inviting a user to Take Picture of Flyer 160 or to revise the search.

At Revise/Narrow Search 130, a user may employ any variety and combination of search filters. For example, a user may enter a different event or flyer location, hashtags, event categories, or other search terms, for example.

At View New Results 140, a page may display a number of results stemming from the new or revised search, along with digital images of flyers and other details such as event information, for example. At View Calendar 150, a user may access a calendar displaying the number of events on each day of a particular week, month, or year, for example. The calendar may display events resulting from a filtered search, for example.

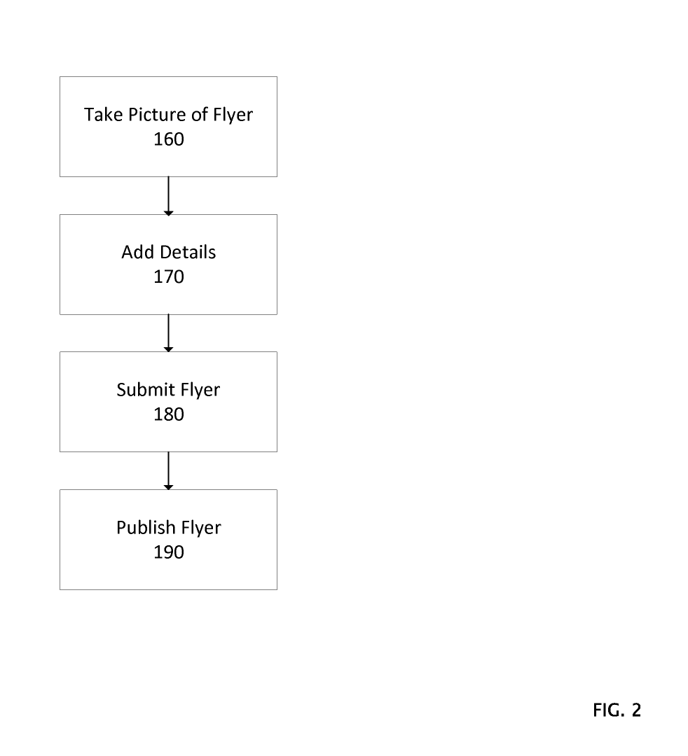

FIG. 2 is a flow diagram illustrating a Digital Flyer Service process according to another embodiment. At Take Picture of Flyer 160, a user may capture an image of any flyer by performing any action such as pressing a button on a mobile device, or a photo may be taken automatically. For example, image or edge detection capabilities may allow pictures to be taken automatically from a video viewfinder on a mobile device. Take Picture of Flyer 160 may utilize and interact with an existing camera and software application on a mobile device. Flyer Digital Service may automatically check a database for duplicate flyers or other information after a user takes a picture but before uploading a photo into the database, for example.

At Add Details 170, a user may manually enter any information which may pertain to a flyer or event, such as cost, date, time, location, or internet links, for example, or opt to have a Digital Flyer Service administrator fill in all or additional details. Digital Flyer Service may also use optical character recognition (OCR) technology to convert photographed images of text into machine-encoded or computer-readable text, for example. Digital Flyer Service may use technology to populate fields automatically and to predict terms such as city names, for example, based on information that a user begins to enter or any other means.

At Submit Flyer 180, the user may upload a flyer onto a searchable database, which may be accessible on a software application on a mobile device, for example. At Publish Flyer 190, the digital image of the flyer, along with any additional details, may be published on the searchable database. The user may receive a confirmation screen, email, SMS message, or any other method of communication indicating that the submission was received and published. At any time, a user may log into the Digital Flyer Service by using any social networking username and password, or any other account or log-in means, for example.

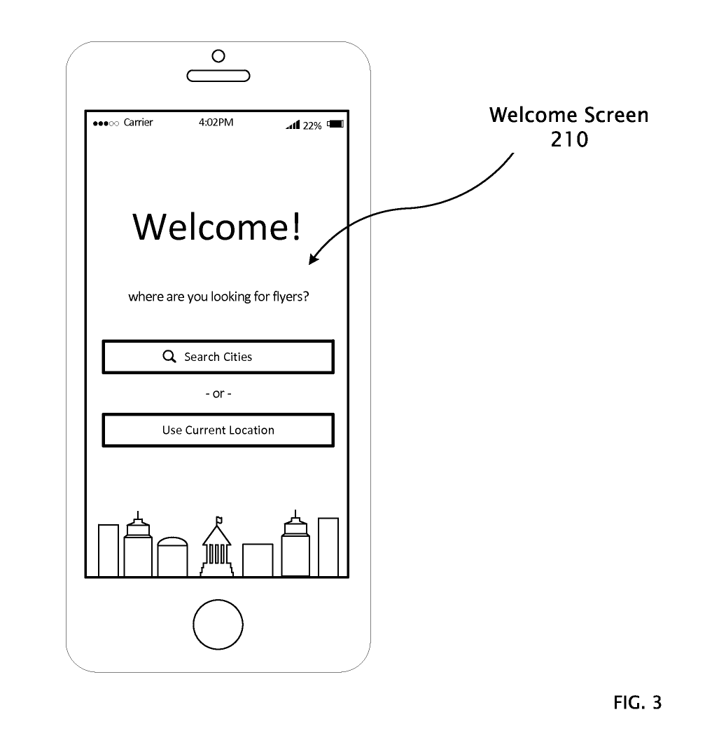

FIG. 3 illustrates a Welcome Screen 210 for a mobile device application using a Digital Flyer Service, according to one embodiment. In this example, a user may search for flyers by entering any location, such as a city, state, zip code, or region, or country, for example, or by using the user's current location as determined by GPS on their mobile device, or any other means.

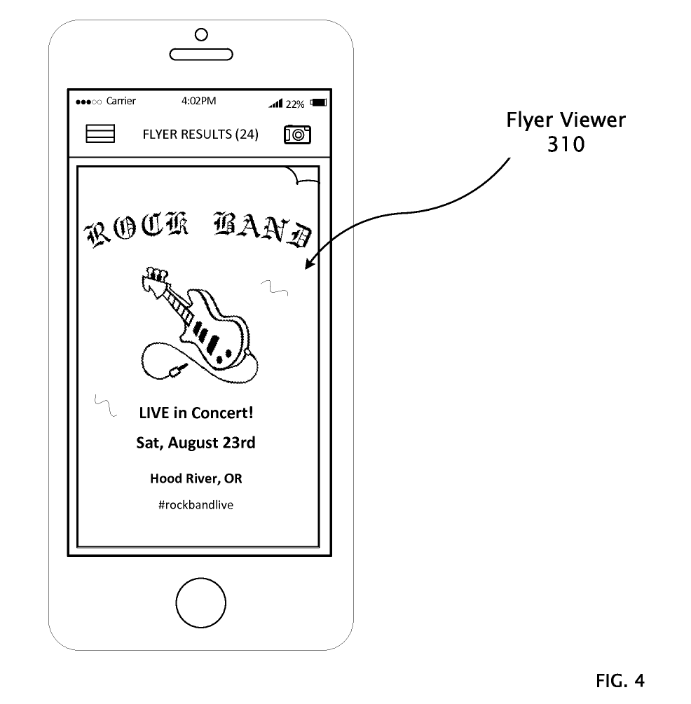

FIG. 4 illustrates a Flyer Viewer 310 for a mobile device application using a Digital Flyer Service, according to one embodiment. In this example, a screen may display a number of results stemming from a search, for example, 24 flyers or events. A user may browse digital images of relevant flyers by, for example, swiping the images in any direction, pressing a button, shaking or tilting a device, or by performing any other action. Images of various flyers may also be displayed automatically. The user may also click on an image to view flyer details, such as event information, and any other links, phone numbers or resources, for example.

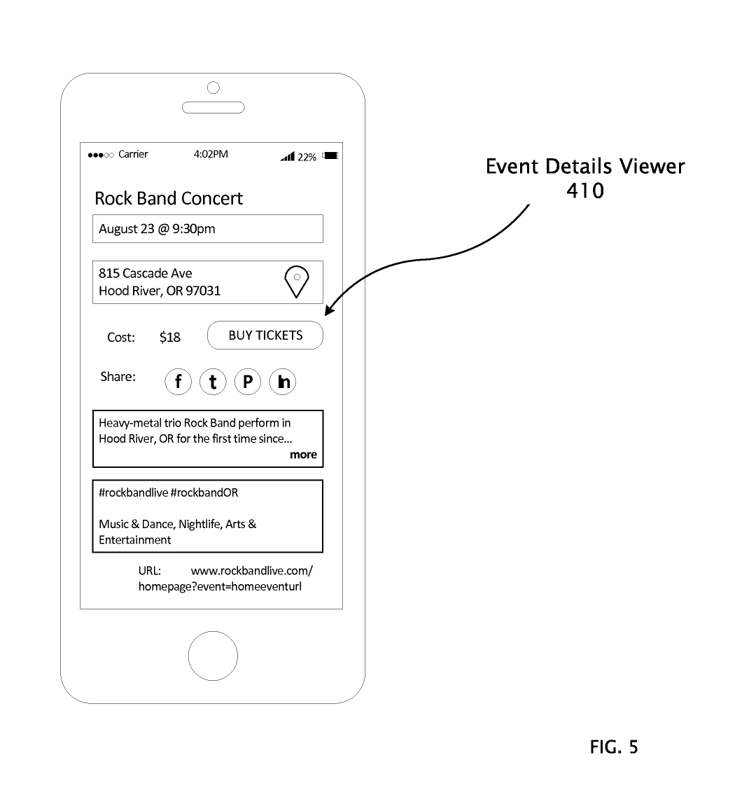

FIG. 5 illustrates an Event Details Viewer 410 for a mobile device application using a Digital Flyer Service, according to one embodiment. Flyer Details may appear upon the happening of any action by a user, or they may appear automatically. In this example, when a user clicks on a flyer image, a screen may display details such as event title, description, cost or suggested donation, date, time, address, search tags, and categories, for example. It may also include links to maps, ticket merchants, social networks such as Facebook, Twitter, Pinterest, and Instagram, or an event URL, for example. In another embodiment, Digital Flyer Service may sell tickets directly to users with Quick Response code (QR code) or any other means such as email, SMS, for text message, for example.

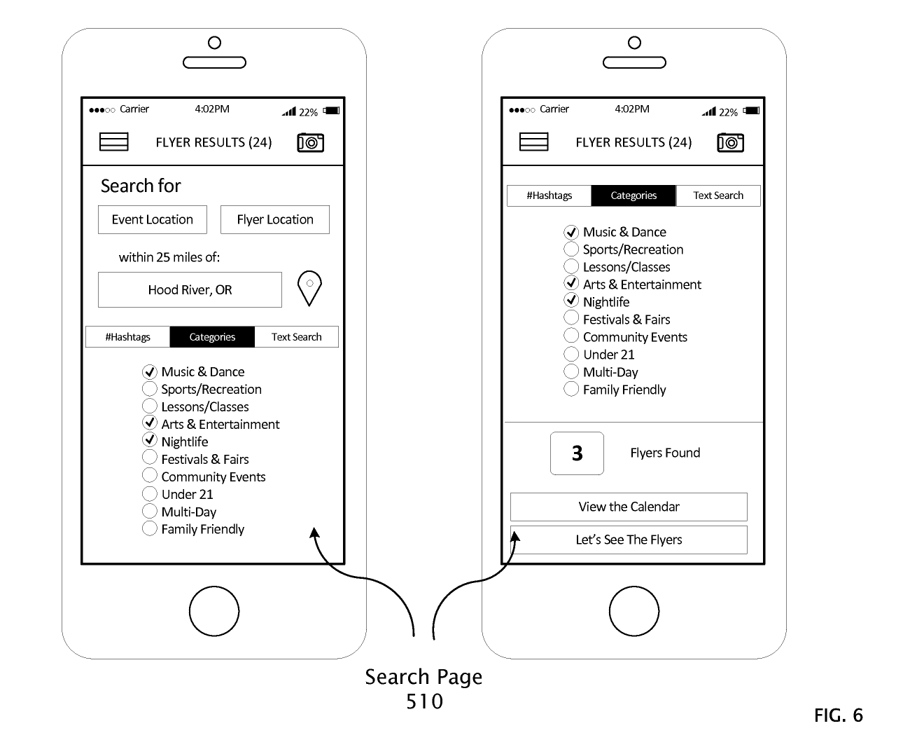

FIG. 6 illustrates a Search Page 510 for a mobile device application using a Digital Flyer Service, according to one embodiment. In this example, a user may revise their initial search or initiate a new search using any variety and combination of search filters. For example, a user may enter a different event or flyer location, hashtags, event categories, or other search terms, for example. A location may comprise any city, state, country, zip code, region, or distance from a particular location, such as 200 miles from London, for example. Event categories may be predetermined and may include Music & Dance, Sports/Recreation, and Family Friendly, for example. The number of results stemming from the new or revised search may be displayed, along with flyer images and other details such as event information, for example. Digital Flyer Service may utilize technology to auto-populate fields with information. It may also use technology to predict terms such as city names, for example, based on information that a user begins to enter, or any other means.

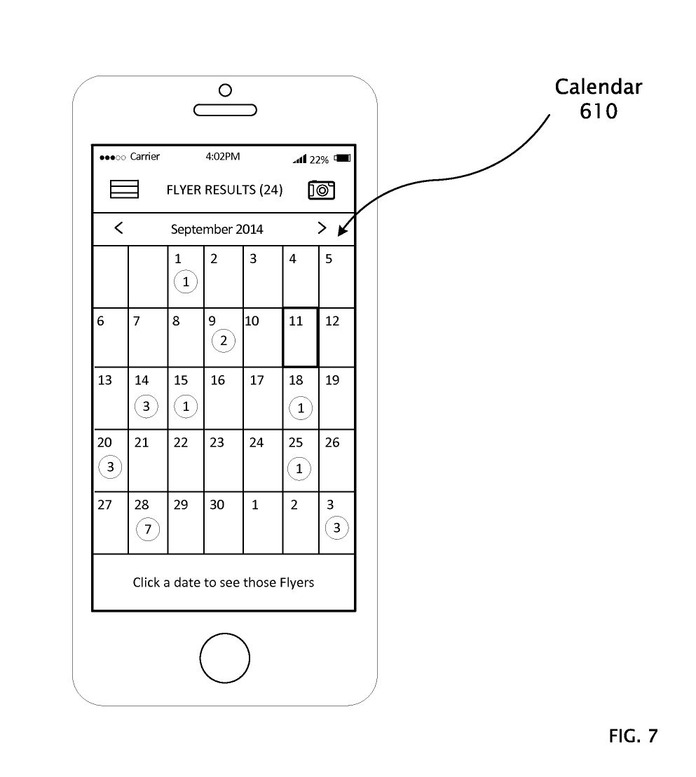

FIG. 7 illustrates a Calendar 610 for a mobile device application using a Digital Flyer Service, according to one embodiment. In this example, Calendar 610 may display the number of events on a particular day, week, month, or year, for example. Calendar 610 may display results stemming from any search, such as a filtered search. Calendar 610 entries may vary in color, style, and other characteristics, for example, depending on factors such as whether the date has passed or is in the future or whether an event is sold out or highly rated, for example. In another embodiment, a list view may be presented. One having skill in the art will recognize that different ways of presenting the data may be used.

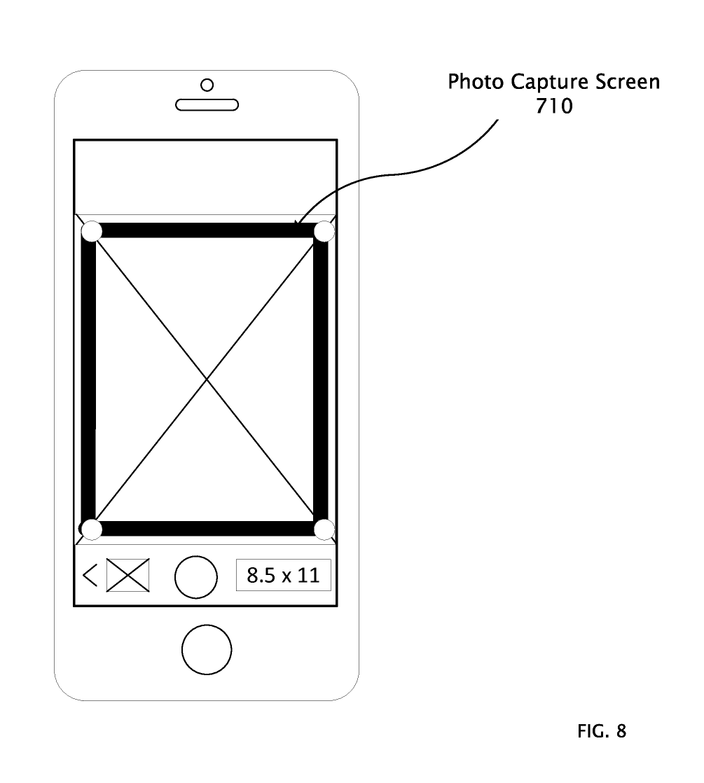

FIG. 8 illustrates a Photo Capture Screen 710 for a mobile device application using a Digital Flyer Service, according to one embodiment. In this example, a user may capture an image of any flyer by performing any action such as pressing a button, or a photo may be taken automatically. For example, images or edge detection technology may automatically take pictures from video viewfinder on a mobile device. Digital Flyer Service may utilize and interact with an existing software application and camera on a mobile device, for example. A user may take a photo of a flyer having any physical size, shape, or other characteristics, and aspect ratios may be made to match real-world print sizes such as 8.5×11, 8.5×14, or 11×17 inches. For example, an 11×17-inch flyer may be captured as a digital photo with an aspect ratio of 320×496, or any other aspect ratio. Digital Flyer Service may also utilize technology allowing a user to taken panoramic photographs of flyers, which may be helpful when a flyer wraps around a cylindrical surface, for example. It may also allow the user to flatten out an image, for example, in the case wherein a flyer had curved edges. The user may also adjust any other characteristics of the flyers such as color, brightness, size, and cropping, for example.

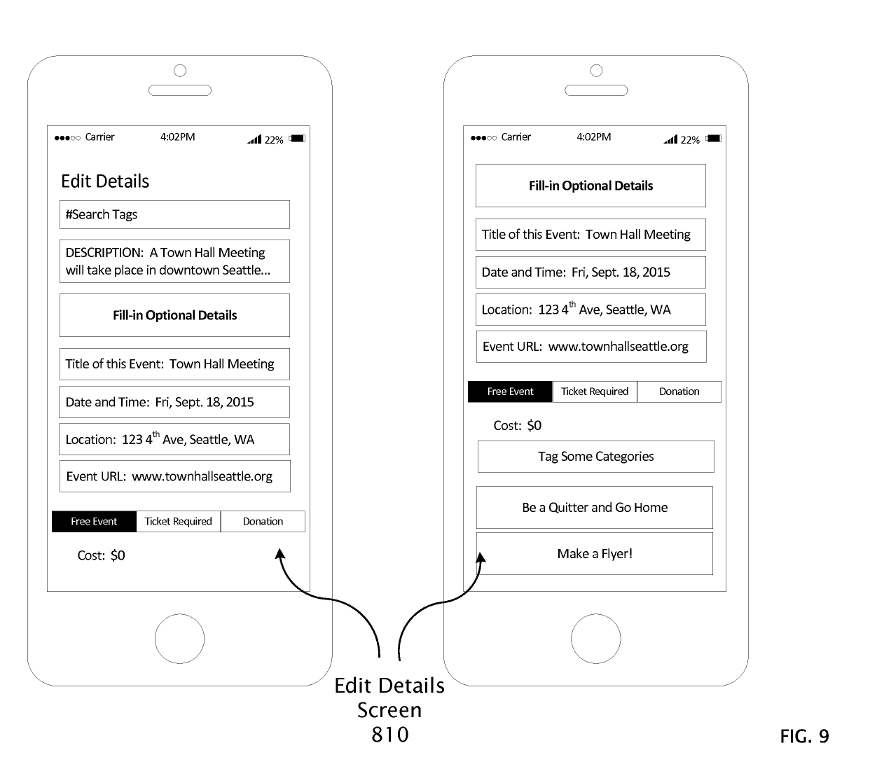

FIG. 9 illustrates an Edit Details Screen 810 for a mobile device application using a Digital Flyer Service, according to one embodiment. In this example, a user may manually enter any information such as event cost, date, time, location, or internet links, for example, or may opt to have an administrator fill in all or any additional details, for example. Digital Flyer Service may utilize technology to auto-populate fields with information and to predict terms. It may also use optical character recognition (OCR) technology to convert photographed images of text, such as flyer details, into machine-encoded or computer-readable text, which may automatically populate fields, for example. After a user edits event details, the user may upload the flyer onto a searchable flyer database, which may be accessible on a software application on a mobile device. The digital image of the flyer, along with any event details, for example, may be published on the searchable flyer database. The user may receive a confirmation by any communication method indicating that the submission was received and published.

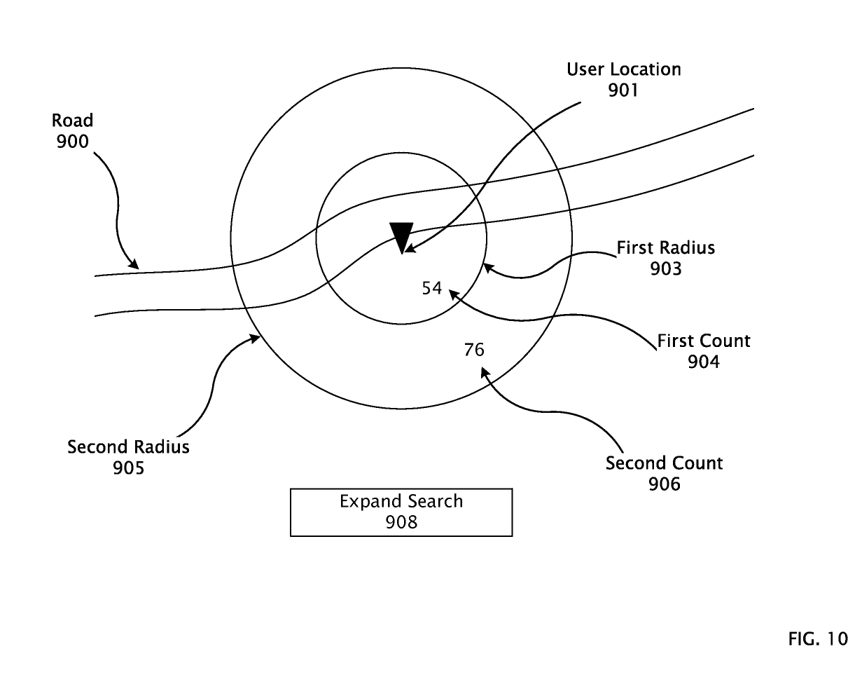

FIG. 10 illustrates a map, with User Location 901 located near Road 900. A user may select First Radius 903 to search for flyers, with First Count 904 indicated 54 flyers matching search criteria were found in that area. The user may Expand Search 908 and see that Second Count 906 indicates 76 flyers matching search criteria were found within Second Radius 905. Searches may be centered on the user location, an event location, a location from which a photo was taken, or any other location.

One having skill in the art will recognize that various user interface designs may be used to reflect this information, and that various search radiuses may be predetermined, or a radius may be entered by a user.

FIG. 10 is a block diagram illustrating an example of a system capable of supporting a Digital Flyer Service, according to one embodiment. Network 910 may include Wi-Fi, cellular data access methods, such as 3G or 4G LTE, Bluetooth, Near Field Communications (NFC), the internet, local area networks, wide area networks, or any combination of these or other means of providing data transfer capabilities. In one embodiment, Network 910 may comprise Ethernet connectivity. In another embodiment, Network 910 may comprise fiber optic connections.

User Device 920, 930, 940 may be a smartphone, tablet, laptop computer, smart watch or intelligent eyewear, or other device with location-based services, for example GPS, cellphone tower triangulation capability, or accelerometers, and may have network capabilities to communicate with Server 950. Server 950 may include one or more computers, and may serve a number of roles. Server 950 may be conventionally constructed or may be of a special purpose design for processing data obtained from a Digital Flyer Service. One skilled in the art will recognize that Server 950 may be of many different designs and may have different capabilities.

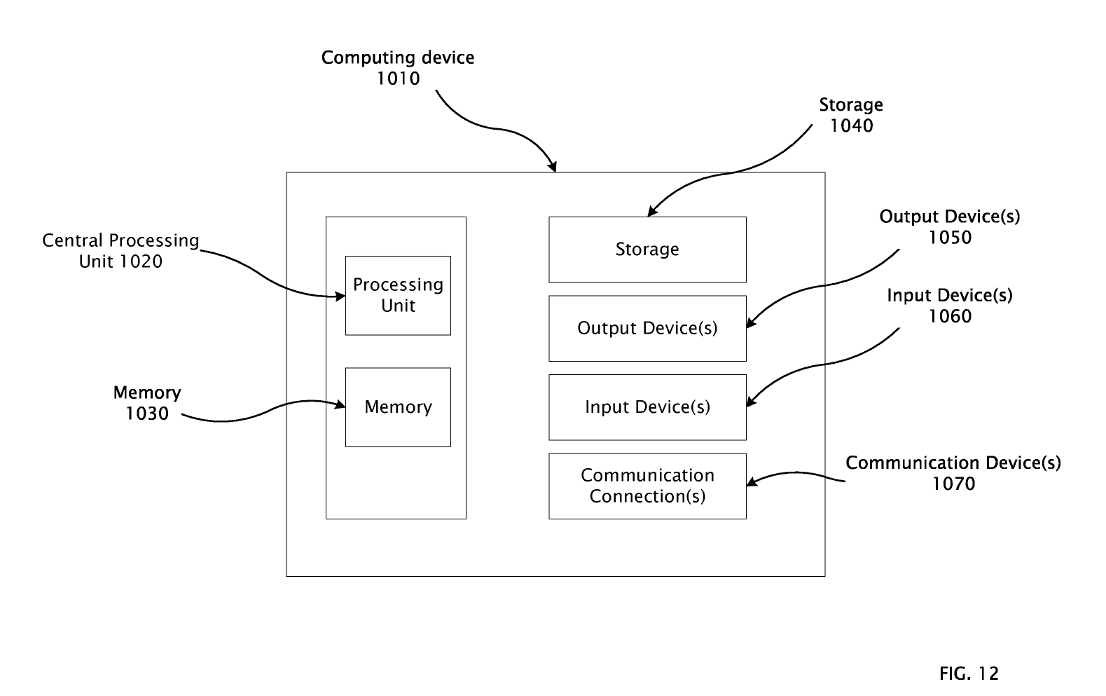

FIG. 12 is a component diagram of a computing device to which a Digital Flyer Service process may be applied according to one embodiment. The Computing Device 1010 can be utilized to implement one or more computing devices, computer processes, or software modules described herein, including, for example, but not limited to a mobile device. In one example, the Computing Device 1010 can be used to process calculations, execute instructions, and receive and transmit digital signals. In another example, the Computing Device 1010 can be utilized to process calculations, execute instructions, receive and transmit digital signals, receive and transmit search queries and hypertext, and compile computer code suitable for a mobile device. The Computing Device 1010 can be any general or special purpose computer now known or to become known capable of performing the steps and/or performing the functions described herein, either in software, hardware, firmware, or a combination thereof.

In its most basic configuration, Computing Device 1010 typically includes at least one Central Processing Unit (CPU) 1020 and Memory 1030. Depending on the exact configuration and type of Computing Device 1010, Memory 1030 may be volatile (such as RAM), non-volatile (such as ROM, flash memory, etc.) or some combination of the two. Additionally, Computing Device 1010 may also have additional features/functionality. For example, Computing Device 1010 may include multiple CPU's. The described methods may be executed in any manner by any processing unit in Computing Device 1010. For example, the described process may be executed by both multiple CPU's in parallel.

Computing Device 1010 may also include additional storage (removable or non-removable) including, but not limited to, magnetic or optical disks or tape. Such additional storage is illustrated in FIG. 4 by Storage 1040. Computer readable storage media include volatile and nonvolatile, removable and non-removable media implemented in any method or technology for storage of information such as computer-readable instructions, data structures, program modules or other data. Memory 1030 and Storage 1040 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 1010. Any such computer-readable storage media may be part of Computing Device 1010. But computer readable storage media do not include transient signals.

Computing Device 1010 may also contain Communications Device(s) 1070 that allow the device to communicate with other devices. Communications Device(s) 1070 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 1010 may also have Input Device(s) 1060 such as keyboard, mouse, pen, voice input device, touch input device, etc. Output Device(s) 1050 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A computer operable method of searching for and digitizing flyers, comprising:
performing a search for flyers based on a location, the flyers corresponding to events planned for the location;
displaying, on a user interface, a result list of the search, the result list comprising digitized pictures of flyers;
receiving an input selecting a flyer from the result list; and
adding the corresponding planned event to a calendar.

2. The method of claim 1, wherein the location refers to a location entered by a user.

3. The method of claim 1, wherein the location is a user's location as determined by a global positioning system (GPS).

4. The method of claim 1, wherein the search results comprise event details from the flyers.

5. The method of claim 1, further comprising purchasing a ticket to the corresponding planned event.

6. The method of claim 1, further comprising:
receiving a photo of a flyer;
digitizing the flyer's details; and
publishing the flyer and its details.

7. The method of claim 6, wherein taking the photo comprises utilizing the built-in camera of a mobile device.

8. The method of claim 6, wherein taking the photo comprises capturing a panoramic digital image of the flyer.

9. The method of claim 6, further comprising editing the photo, the editing selected from the list containing cutting, cropping, adjusting brightness, color, contrast, and flattening.

10. The method of claim 6, wherein digitizing the flyer's details comprises converting digital letters and characters into text.

11. The method of claim 6, wherein digitizing the flyer's details comprises a user manually entering event details.

12. The method of claim 6, wherein digitizing the flyer's details comprises an administrator entering event details.

13. A system, comprising:
a processor;
a memory operably coupled to the processor; and
components disposed in the memory, the components being operable by the processor, comprising:
a flyer searching component, configured to search a database for flyers;
a photo capturing component, configured to capture and digitize images of flyers;
a publishing component, configured to publish a flyer and its details to the database.

14. Computer readable storage media containing instructions thereon which, when executed by a processor, perform a method comprising:
performing a search for flyers based on a location, the flyers corresponding to events planned for the location;
displaying, on a user interface, a result list of the search, the result list comprising digitized pictures of flyers;
receiving an input selecting a flyer from the result list; and
adding the corresponding planned event to a calendar.
